(19) United States
(12) Patent Application Publication
(10) Pub. No.: US 2014/0042797 A1
(43) Pub. Date: Feb. 13, 2014

(54) Retrofit Wheel Kit

(71) Applicants: Carol Lee Pillow, Lexington, TN (US); Millard O'Neal Morgan, Lexington, TN (US)

(72) Inventors: Carol Lee Pillow, Lexington, TN (US); Millard O'Neal Morgan, Lexington, TN (US)

(21) Appl. No.: 13/572,664

(22) Filed: Aug. 12, 2012

(51) Int. Cl. B60B 5/02

(52) U.S. Cl. 301/64.706

(57) ABSTRACT

Embodiments of the present invention are directed at least to a plastic wheel, methods of making a plastic wheel, a longitudinal shaft to support said plastic wheel, and a restraining element to secure said plastics wheel to said longitudinal shaft. The wheel construction consists of a pair of blow molded relatively hard rigid bodies with a centrally located cavity configured to receive a supporting element, such as an axle. The first body when viewed from the outside has the general appearance of a wheel with a tread pattern. The second body when viewed from the inside has a substantial protrusion dimensioned and configured to occupy a cavity.

### BACKGROUND OF THE INVENTION

1. Field of the Invention

The subject matter relates at least to portable food and beverage containers used widely in the recreational accessory industry. More specifically, a retrofit wheel assembly is disclosed for converting wheeled food and beverage containers, such as an ice chest, to an accessory that can travel easily through sand, gravel and tall grass. The retrofit assembly, when installed on a recreational accessory, provides more ground clearance and spreads the weight of that accessory across a larger footprint than the original equipment installed at the time of manufacture.

2. Description of the Art

The art of some form of recreational accessory used to carry food, drinks and other accessories to the beach, lake, river, ball fields, and other locations is extensive. However, the fact is, ice chests, coolers, tote bags, radios, chairs, blankets, umbrellas, air mattresses, and much more are being carried or dragged to their destinations due to the poor design of their wheels and supporting elements. This invention offers an easy and inexpensive fix for the millions of recreational accessories already purchased around the world.

3. References:

| | | |
|---|---|---|
| 8,147,005 | Apr. 3, 2012 | Morris, Michael A. |
| 6,520,507 | Feb. 18, 2012 | Markling, Floyd F. |
| 7,963,530 | Jun. 21, 2011 | Garcia, Oscar |
| D613,560 | Apr. 13, 2010 | Robichaud, David |
| 7,559,559 | Jul. 14, 2009 | Vanderberg, Matthew A. |
| 7,188,491 | Mar. 13, 2007 | Donald, Gerald W. |
| 7,108,335 | Sep. 19, 2006 | Morris, Michael |
| 6,755,428 | Jun. 29, 2004 | Butler, David |
| 6,739,150 | May 25, 2004 | Garcia, Mampo |
| 6,637,835 | Oct. 28, 2003 | Morris, Michael |
| 6,626,453 | Sep. 30, 2003 | Theus, Robert & Elizabeth Ann |
| 6,543,800 | Apr. 8, 2003 | Doran, Gerald M. |
| 6,533,298 | Mar. 18, 2003 | Sims, Charles |
| 6,505,843 | Jan. 14, 2003 | Williams, Dale |

### SUMMARY OF THE INVENTION

The Retrofit Wheel Kit for recreational accessories of this invention is designed to make other products already patented, more useful and easier to enjoy. For example, food and beverage containers manufactured with small wheels do meet the mobile aspect requirements of the patent. However, these products can be seen being dragged or even carried at the beach due to the inadequacy of the wheels and their support mechanism. With the Retrofit Wheel Kit installed, the product will roll easily on sand and other surfaces. In addition, the design of the wheel will allow coolers, ice chests, and other recreational accessories to not only carry their own weight, but the weight of other accessories.

The wheel of this invention comprises an asymmetrical relatively hard and rigid molded thermoplastic resin. The wall portions engage the hub portion which supports the radial load long a longitudinal shaft held in place by a restraining element at each opposing end.

The restraining element, such as a hitch pin clip, is removable and reusable in order for the large wheels to be removed for easy transportation and storage of the accessory.

### BRIEF DESCRIPTION OF THE DRAWINGS

In the drawings:

FIG. 1 is a frontal exploded view of the retrofit wheel kit for a recreational accessory.

FIG. 2 is a frontal cutaway view of the wheel element of the retrofit wheel kit.

FIG. 3 is a frontal view of a recreational accessory with the retrofit wheel kit installed.

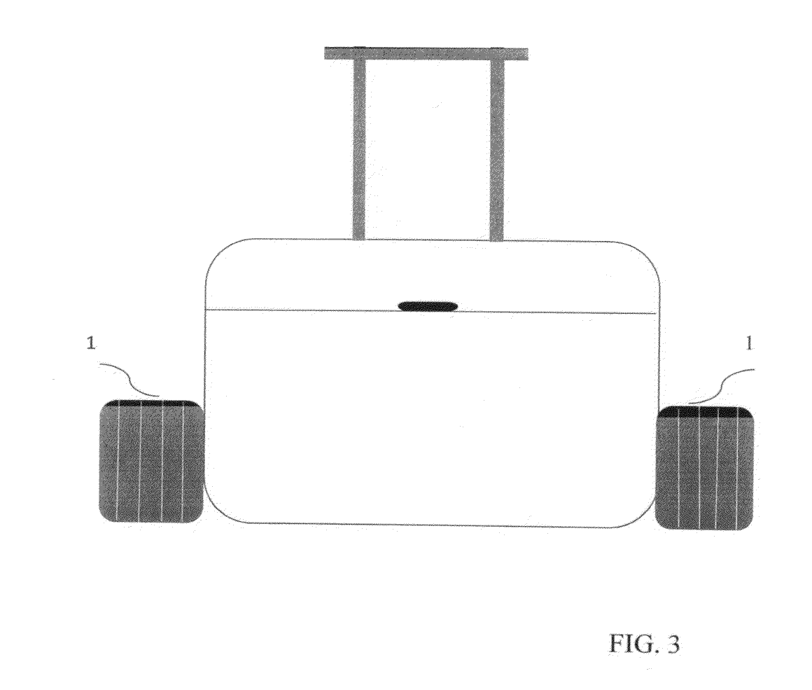

FIG. 4 is a view of the rear of a recreational accessory with the retrofit wheel kit installed.

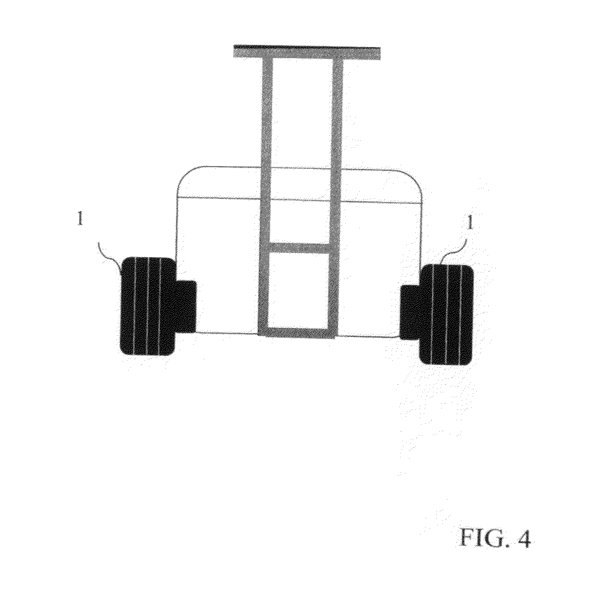

FIG. 5 is a side view of a recreational accessory with the retrofit wheel kit installed.

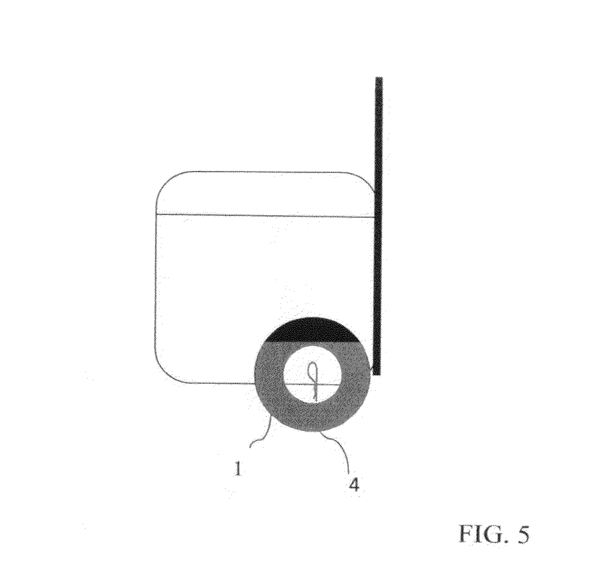

FIG. 6 is a top view of a recreational accessory with the retrofit wheel kit installed.

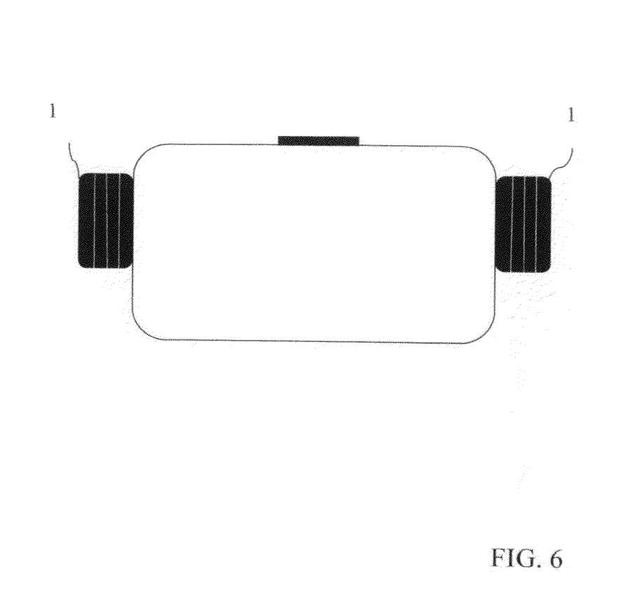

FIG. 7 is a bottom view of a recreational accessory with the retrofit wheel kit installed.

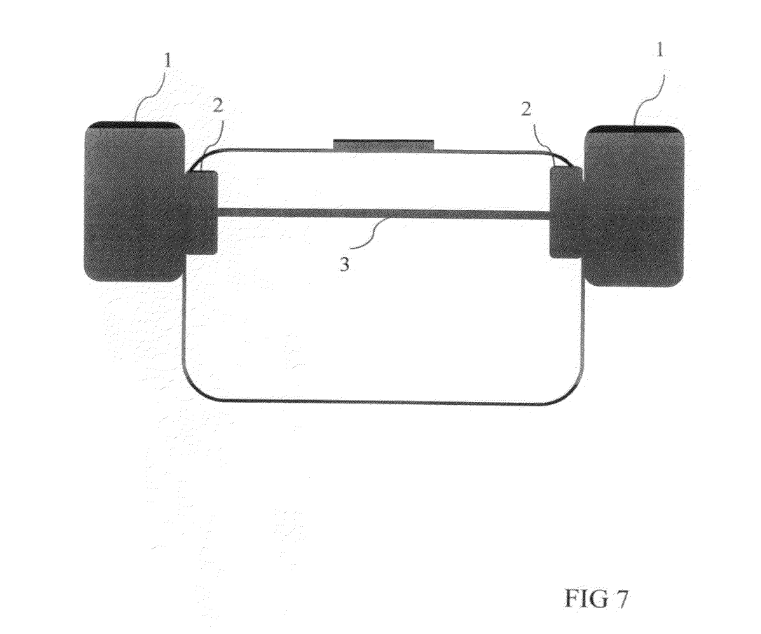

FIG. 8 is a front view of the axle retaining elements of the retrofit wheel kit.

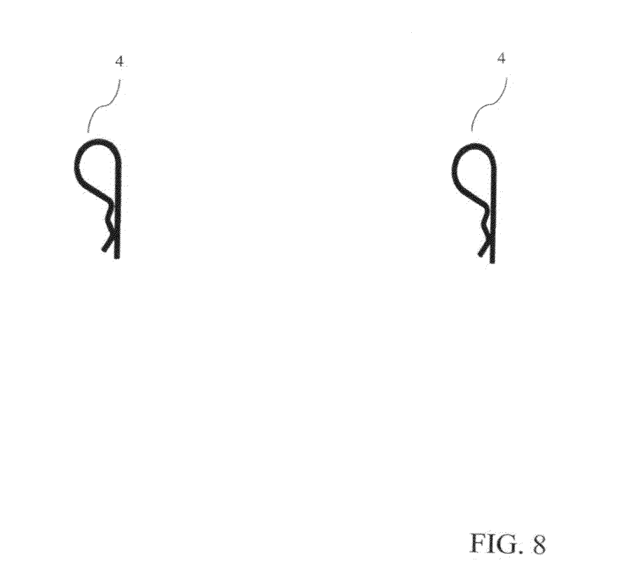

FIG. 9 is a front view of the axle element of the retrofit wheel kit.

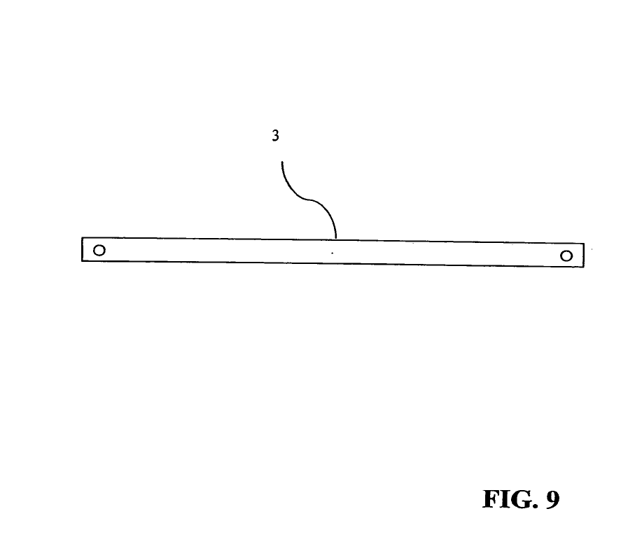

### DESCRIPTION OF THE PREFERRED EMBODIMENT

Referring now more particularly to the drawings, reference numbers will be used to denote the like parts or structure features in the different views.

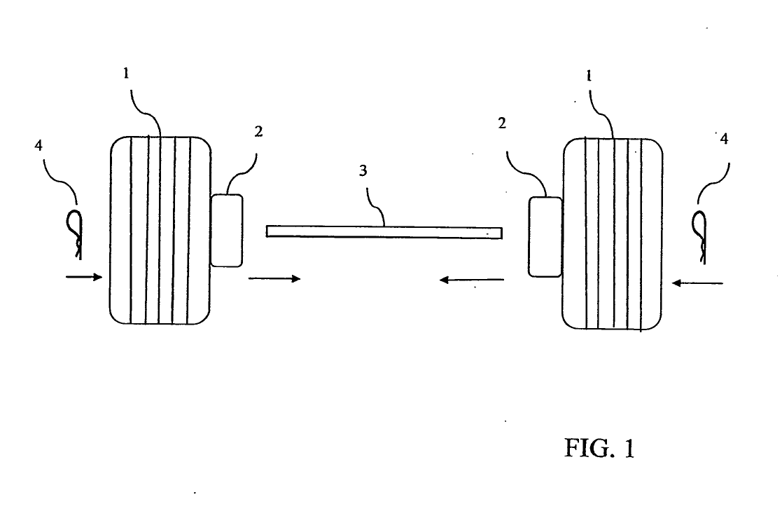

The wheel element of this invention referred to in FIG. 1 will be referenced throughout with the number 1. That number will refer to a solid molded cavernous body that is cast or molded in unitary form of a rigid material such as plastic. At its center a hub 5 is formed to receive a supporting element made of hard metal, such as an axle 3. Axle 3, has an opening located at each of its ends to receive a securing element 4. The asymmetrical part of the wheel 2 is dimensioned and configured to occupy the cavity of a recreational accessory when that accessory has its original wheels removed. Each molded cavernous body 1 is held in place by a securing element 4, such as a hitch pin clip.

The asymmetrical portion of the wheel element 1 is referred to in FIG. 1 will be referenced throughout with the number 2.

The supporting element of the wheel element 1 referred to in FIG. 1 will be referenced throughout with the number 3.

The securing element of the wheel element 1 referred to in FIG. 1 will be referenced through out with the number 4.

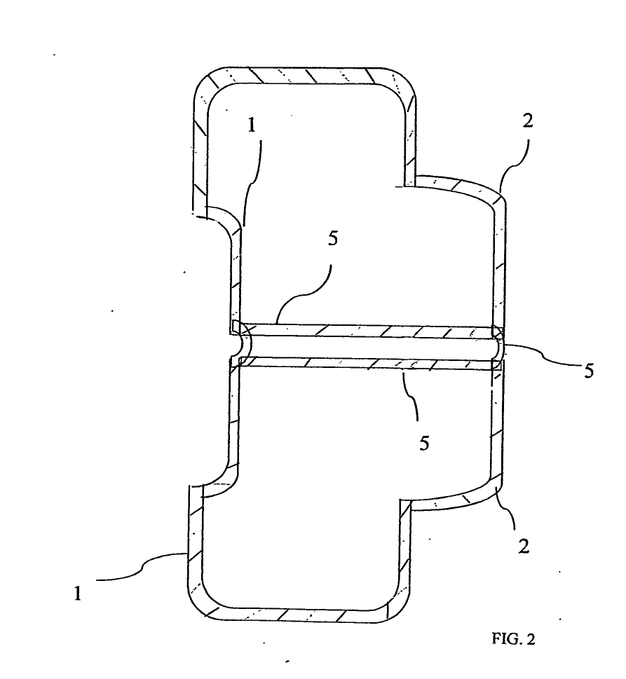

The axle bore 5 referred to in FIG. 2 is dimensioned and configured to snuggly receive the securing element 4 in order to prevent relative axial movement.

What is claimed is:

1. A retrofit wheel kit comprising:

2. Two molded shell-like bodies each having a centrally located hub portion and a substantial protrusion dimensioned and configured to occupy a cavity on one of its sides.

3. The centrally located hub portion of claim 2 is configured to receive a supporting longitudinal shaft.

4. The two molded shell-like bodies in claim 2 are supported by the longitudinal shaft in claim 3 and connected together upon said longitudinal shaft of claim 3 by a securing element at each of its ends.
